(19) United States
(12) Patent Application Publication
(10) Pub. No.: US 2022/0004949 A1
(43) Pub. Date: Jan. 6, 2022

(54) SYSTEM AND METHOD FOR ARTIFICIAL INTELLIGENCE (AI)-BASED ACTIVITY TRACKING FOR PROTOCOL COMPLIANCE

(71) Applicant: Cherry Labs, Inc., Wilmington, DE (US)

(72) Inventors: Maksim Goncharov, Redwood City, CA (US); Margarita Goncharova, Redwood City, CA (US); Jiunn Benjamin Heng, Los Altos Hills, CA (US)

(21) Appl. No.: 17/478,691

(22) Filed: Sep. 17, 2021

Related U.S. Application Data
(63) Continuation-in-part of application No. 17/353,210, filed on Jun. 21, 2021.
Application No. 17/353,210 is a continuation of application No. PCT/US21/24302, filed on Mar. 26, 2021.
Application No. PCT/US21/24302 is a continuation-in-part of application No. 17/353,281, filed on Jun. 21, 2021.
Application No. 17/353,281 is a continuation of application No. PCT/US21/24306, filed on Mar. 26, 2021.
(60) Provisional application No. 63/232,874, filed on Aug. 13, 2021.
(60) Provisional application No. 63/001,844, filed on Mar. 30, 2020.
(60) Provisional application No. 63/001,862, filed on Mar. 30, 2020.

(51) Int. Cl. G06Q 10/06; G06K 9/00

(52) U.S. Cl. CPC G06Q 10/0635; G06K 9/00335; G06Q 10/06395

(57) ABSTRACT

A new approach is proposed to support activity tracking of a person for protocol compliance. The proposed approach tracks a sequence of activities of the person at one or more zones of interest being monitored via one or more cameras and/or sensors to determine if the person is following a set of pre-determined protocols at the zones of interest. Under the proposed approach, a plurality of AI models are trained and utilized to define the one or more zones of interest, to detect presence and classification of the person and/or an object associated with the person, to determine/classify the sequence of activities of the person, and to determine duration of the sequence of activities. The sequence of activities of the person is then checked against the set of pre-determined protocols to determine if the person is in protocol compliance or not and protocol violations are reported to a user.

### CROSS-REFERENCE TO RELATED APPLICATIONS

This application claims the benefit of U.S. Provisional Patent Application No. 63/232,874, filed Aug. 13, 2021, which is incorporated herein in its entirety by reference.

This application is a continuation-in-part of co-pending U.S. patent application Ser. Nos. 17/353,210 and 17/353,281, both filed Jun. 21, 2021 and incorporated herein in their entireties by reference. Ser. No. 17/353,210 is a continuation of PCT/US21/24302 filed Mar. 26, 2021, which claims benefit of U.S. Provisional Patent Application No. 63/001,844 filed Mar. 30, 2020. Ser. No. 17/353,281 is a continuation of PCT/US21/24306 filed Mar. 26, 2021, which claims benefit of U.S. Provisional Patent Application No. 63/001,862 filed Mar. 30, 2020.

This application is related to co-pending U.S. patent application Ser. No. ______, filed ______, and entitled “SYSTEM AND METHOD FOR ARTIFICIAL INTELLIGENCE (AI)-BASED PROTOCOL COMPLIANCE TRACKING FOR WORK PLACE APPLICATIONS,” which is incorporated herein in its entirety by reference.

### BACKGROUND

A variety of security, monitoring, and control systems equipped with a plurality of cameras, audio input devices, and/or sensors have been used to detect certain human presence or a particular human activity at a monitored location (e.g., home or office). For a non-limiting example, motion detection is often used to detect intruders in vacated homes or buildings, wherein the detection of an intruder may lead to an audio or silent alarm and contact of security personnel. Video monitoring is also used to provide additional information about personnel living in, for a non-limiting example, an assisted living facility. These systems, however, often lack context or feedback loop on whether a sequence of activities has occurred in a certain zone or location of interest by a person. In many cases, a snapshot of what happened at the location is collected by the devices/sensors to try to piece together whether this occurrence is part of the normal trend or is an abnormal event. As such, it is impossible for current approaches to intelligently determine if a certain protocol or procedure has been complied with or violated. Checking and ensuring protocol compliance in workplace environments, such as factories and hospital, is especially important as many of the health/safety protocols encompass a collection of events/activities that must be executed by specific person(s) in a specific order in a particular area of interest.

The foregoing examples of the related art and limitations related therewith are intended to be illustrative and not exclusive. Other limitations of the related art will become apparent upon a reading of the specification and a study of the drawings.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 depicts an example of a system diagram to support protocol compliance tracking in accordance with some embodiments.

FIG. 2 depicts an example of how user information is transmitted in accordance with some embodiments.

FIG. 3 depicts an example of an image where a person's body is pixelized by applying a layer of privacy blocks each of 50×50 pixels in size to potential sensitive areas in the image in accordance with some embodiments.

FIGS. 4A-4C depict examples of various use cases where protocol compliance is required to ensure employees are following production protocols/procedures in order to adhere to operational efficiency requirement in accordance with some embodiments.

FIG. 5 depicts a flowchart of an example of a process to support protocol compliance tracking in accordance with some embodiments.

### DETAILED DESCRIPTION OF EMBODIMENTS

The following disclosure provides many different embodiments, or examples, for implementing different features of the subject matter. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

A new approach is proposed that contemplates systems and methods to support activity tracking of a person for protocol compliance. Specifically, the proposed approach tracks a sequence of postures and/or activities of the person at one or more zones of interest being monitored via one or more cameras and/or sensors to determine if the person is following a set of pre-determined/prescribed procedures/protocols. Under the proposed approach, a plurality of AI models are trained and utilized to define the one or more zones of interest for monitoring the person, to detect presence and classification of the person and/or an object associated with the person, to determine/classify the sequence of activities of the person, and to determine duration of the sequence of activities. Here, the one or more zones of interest can be in a working environment or a rehabilitation regime (e.g., a nursery facility) that requires protocol compliance. The sequence of activities of the person at the zones of interest is then checked against the set of pre-determined protocols to determine whether the person is in protocol compliance or not. If it is determined that the person is not in compliance with the set of protocols, a user (e.g., an employer or a healthcare professional) will be notified and remedial measures will be taken.

By tracking persons' activities in the zones of interest, the proposed approach ensures protocol compliance by employees at work and/or patients under care for the safety of the employees and/or the care of the patients. In some embodiments, the proposed approach also reduces latency and enables rapid response for protocol compliance in a real-time work/living environment, especially when the protocol compliance is related directly to human safety. Moreover, the proposed approach protects privacy and confidentiality of information collected by pixelizing/blurring images of the person/object under surveillance and storing the data in a secure storage unit onsite.

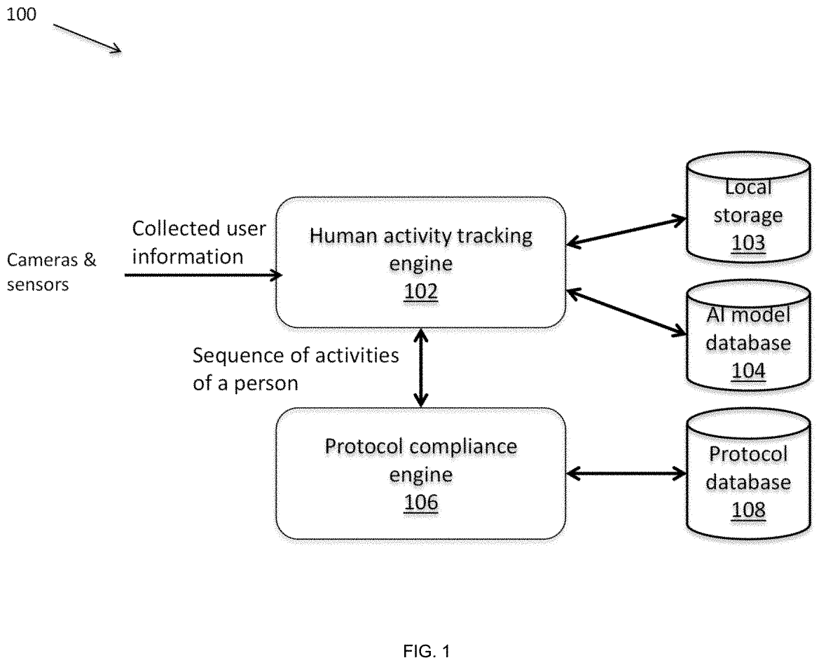

FIG. 1 depicts an example of a system diagram 100 to support protocol compliance tracking. Although the diagram depicts components as functionally separate, such depiction is merely for illustrative purposes. It will be apparent that the components portrayed in this figure can be arbitrarily combined or divided into separate software, firmware and/or hardware components. Furthermore, it will also be apparent that such components, regardless of how they are combined or divided, can execute on the same host or multiple hosts, and wherein the multiple hosts can be connected by one or more networks.

In the example of FIG. 1, the system 100 includes one or more of a human activity tracking engine 102, a secured local storage 103, an AI model database 104, a protocol compliance engine 106, and a protocol database 108. These components in the system 100 each runs on one or more computing units/appliances/devices/hosts (not shown) each having one or more processors and software instructions stored in a storage unit, such as a non-volatile memory (also referred to as secondary memory) of the computing unit for practicing one or more processes. When the software instructions are executed by the one or more processors, at least a subset of the software instructions is loaded into memory (also referred to as primary memory) by one of the computing units, which becomes a special purpose computing unit for practicing the processes. The processes may also be at least partially embodied in the computing units into which computer program code is loaded and/or executed such that the host becomes a special purpose computing unit for practicing the processes.

In the example of FIG. 1, each computing unit can be a computing device, a communication device, a storage device, or any computing device capable of running a software component. For non-limiting examples, a computing device can be but is not limited to a server machine, a laptop PC, a desktop PC, a tablet, a Google's Android device, an iPhone, an iPad, and a voice-controlled speaker or controller. Each computing unit has a communication interface (not shown), which enables the computing units to communicate with each other, the user, and other devices over one or more communication networks following certain communication protocols, such as TCP/IP, http, https, ftp, and sftp protocols. Here, the communication networks can be but are not limited to, Internet, intranet, wide area network (WAN), local area network (LAN), wireless network, Bluetooth, WiFi, and mobile communication network. The physical connections of the network and the communication protocols are well known to those skilled in the art.

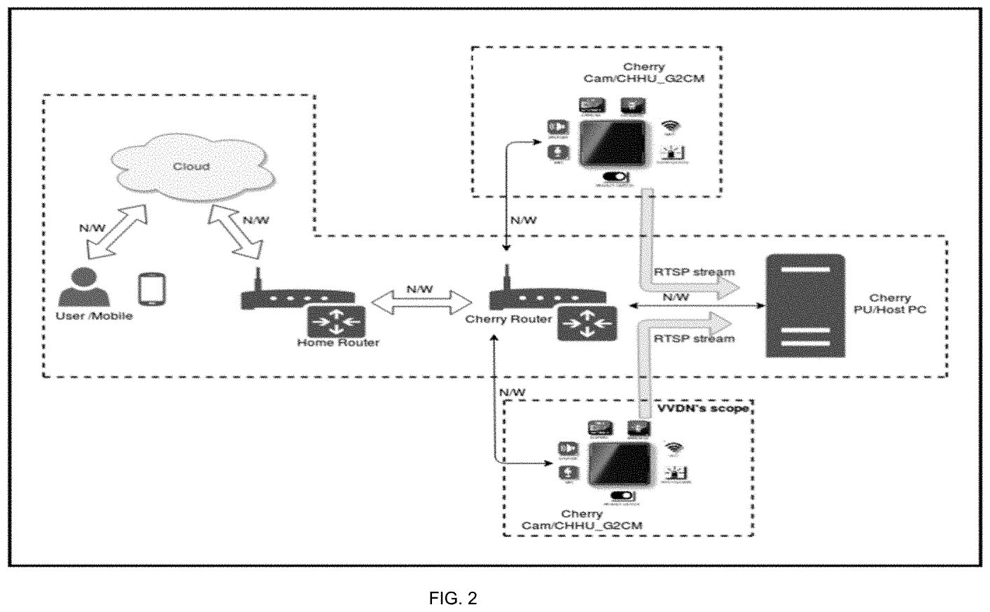

In the example of FIG. 1, the human activity tracking engine 102 is configured to accept information of a person under surveillance including video, audio streams, and other data of the person collected by one or more cameras, audio input devices (e.g., microphones), and/or sensors at a monitored location (e.g., one or more zones of interest). The information is transmitted to the human activity tracking engine 102 via wireless or ethernet connection under a communication protocol. In some embodiments, the communication protocol is Real Time Streaming Protocol (RTSP), which is a network control protocol designed for use to control streaming media. In some embodiments, the information of the person collected at the zones of interest is accepted by the human activity tracking engine 102 for further analysis, which includes but is not limited to body images, postures and/or activities of the person, and the durations of the activities. FIG. 2 depicts an example of how the information of the person is transmitted to the human activity tracking engine 102 via, for non-limiting examples, wireless or ethernet connections through routers, networks and/or cloud. In some embodiments, the human activity tracking engine 102 is either located at the monitoring location or is located remotely at a different location.

In some embodiments, the human activity tracking engine 102 is configured to maintain the collected information (e.g., images, video, and/or audio) of the person in a secured local storage 103, which can be a data cache associated with the human activity tracking engine 102, to ensure data privacy and security of the person. In some embodiments, the data locally maintained in the secured local storage 103 can be accessed by the human activity tracking engine 102 and/or protocol compliance engine 106 via an Application Programming Interface (API) only under strict data access control policies (e.g., only accessible for authorized personnel or devices only) to protect the person's privacy. In some embodiments, information retrieved from the secured local storage 103 is encrypted before such information is transmitted over a network for processing or before being accessed by an authorized application or a web-based service. In some embodiments, the secured local storage 103 resides onsite behind a user's firewall. Note that none of the sensitive video/audio of the person leaves the secured local storage 103, hence guaranteeing the person being monitored at the location/zone of interest has full control of his/her data, which is particularly important in highly confidential manufacturing or work areas as well as in sensitive/private hospital or healthcare environment.

In some embodiments, the human activity tracking engine 102 is configured to generate, train, and utilize a plurality of AI models to track and identify the sequence of activities of the person at the monitored location/zone of interest. In some embodiments, the human activity tracking engine 102 is configured to maintain the plurality of AI models in an AI model database 104. In some embodiments, the human activity tracking engine 102 is configured to train the plurality of AI models using the collected information of the person and/or other persons being monitored over a period of time. By utilizing the plurality of AI models, the human activity tracking engine 102 builds a sequence of events/activities executed by a person or object at the one or more zones of interest over a certain amount of time. Such sequence of events/activities enables the users (e.g., employers, healthcare professionals, production/safety managers etc.) of the system 100 to ensure that a set of pre-defined protocols is followed by the person, who can be but is not limited to an employee, a factory operator, a recovering patient, elderly in therapy etc.

In some embodiments, the human activity tracking engine 102 is configured to monitor, track, and identify the sequence of activities of the person at the one or more zones/locations of interest, wherein the zones of interest are a pre-defined/prescribed space or area where the set of compliance protocols must be followed. For non-limiting examples, each of the one or more zones of interest can be but is not limited to a factory floor area where personal protection equipment (PPE) must be used or a designated area for health care where physical therapy has to be performed. In some embodiments, the human activity tracking engine 102 is configured to systematically define/mark out the zones of interest such that if an activity, a person, or an object is detected in the zones of interest by the human activity tracking engine 102, a series of actions will be triggered to ascertain if the set of protocols for the zones of interest is followed.

In some embodiments, the human activity tracking engine 102 is configured to detect the presence of a person or an object on, associated with, or around the person at the zone of interest subject to the set of protocols in order to determine if compliance with the set of protocols is maintained. For non-limiting examples, the human activity tracking engine 102 can detect a forklift in an unauthorized factory work area, or a person in a dangerous no-go zone in a manufacturing equipment area. In some embodiments, the human activity tracking engine 102 is configured to utilize the plurality of trained AI models to recognize, identify, and classify a certain human posture or an action of the person with a small number of (one or more) still images taken at the one or more zoned of interest. Such “few-shot learning” approach sets a baseline of the specific human posture/action required for compliance with a certain set of protocols for the person under surveillance (e.g., an employee, a patient, or a healthcare professional). The specific baseline set by the “few-shot learning” approach is used to determine if the person has actually followed the set of protocols required at the one or more zones of interest. For a non-limiting example, images of an employee action of using hand sanitization can be captured and used to train the AI models such that the protocol compliance engine 106 can be triggered each time this particular person or action in the zones of interest is detected by the human activity tracking engine 102. For another non-limiting example, images of a patient pulling out intravenous tubes from his/her body require the human activity tracking engine 102 to immediately notify the protocol compliance engine 106 and/or the designated personnel. While the “few-short learning” approach trains the AI models using a few images, in some embodiments, the human activity tracking engine 102 is configured to train the AI models, e.g., an activity recognition model, using a large dataset.

In some cases, the set of protocols may require the person to be present in a designated zone of interest or perform an activity for a certain period of time. In some embodiments, the human activity tracking engine 102 is configured to track and/or record the amount of time the person spent in the zone of interest or spent doing certain activities in order to ascertain the person's compliance with the set of protocols. For a non-limiting example, the human activity tracking engine 102 is configured to track if a patient walks for a certain period of time or if a worker operates an equipment for a minimum amount of time in compliance with the timing requirements of the protocols.

Once the sequence of activities of the person at the one or more zones of interest has been detected, the sequence of activities of the person is provided to the protocol compliance engine 106, which is configured to determine whether the sequence of activities of the person at the zone of interest follows the set of pre-defined protocols or not. Here, the set of pre-defined protocols or procedures executed/followed by the person (e.g., an employer or prescribed by a healthcare professional) includes one or more of ranges or scopes of the zones of interest where the activities of the person is being monitored, presence of the person and/or his or her activities in the zones of interest allowed, and the duration of the person's activities in the zones of interest permitted. In some embodiments, the set of protocols or procedures can be maintained in a protocol database 108 and retrieved by the protocol compliance engine 106 to check the person for protocol compliance. If the protocol compliance engine 106 determines that the sequence of activities of the person at the zone of interest has violated the set of protocols, the protocol compliance engine 106 is configured to document and/or notify/report such violation to the user of the system 100, e.g., the designated person-in-charge, in the form of one or more of alarms, instant messages, dashboards, notifications/escalations, and reports in order to correct/recover the situation, etc. In some embodiments, the protocol compliance engine 106 is configured to alert the person directly, e.g., via emails or phone calls, that his/her activities are not in compliance with the set of protocols and need to be corrected. For example, the protocol compliance engine 106 is configured to turn on an alarm signal or broadcast an audio message to the zone of interest where the person is present and the violating activities have happened. The purpose is to enforce the set of protocols to ensure the well-being or the patients, the safety of the employees, or even the efficiency of the workforce. In some embodiments, the protocol compliance engine 106 is configured to accept input from an existing alarm system (e.g., Andon lights, Sound alarms etc.) to identify/classify an escalation event when a safety compliance protocol or an operation procedure is being violated. In some embodiments, the protocol compliance engine 106 is configured to utilize any existing alarm system (e.g., sound or light) to notify the person of the violation event in order to minimize the risk to the person and/or other affected/surrounding person(s), e.g., a forklift out of control in a work zone or a chemical spill due to non-compliance of maintenance protocols. In some embodiments, all communications between the protocol compliance engine 106 and the user are encrypted to ensure data security.

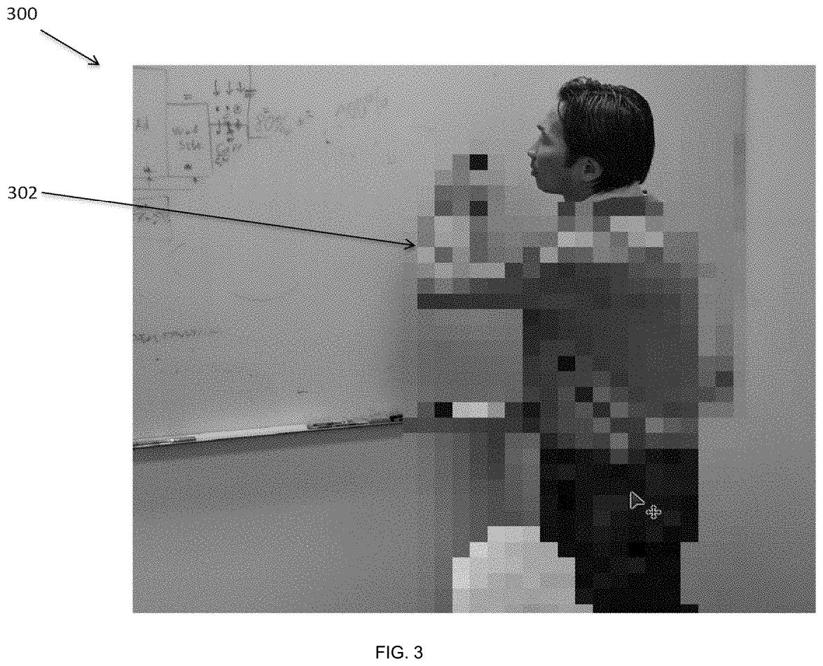

In some embodiments, when reporting a protocol violation to the user, the protocol compliance engine 106 is configured to protect privacy and/or identity of the person by pixelizing or blurring (e.g., by applying blocks or mosaics over) a portion of the body of the person in an image. FIG. 3 depicts an example of an image 300 where a person's body 302 is pixelized by applying a layer of privacy blocks each of 50×50 pixels in size to potential sensitive areas in the image 300. Note that the size of blocks for pixelization can be varied. By pixelizing the human body 302 of the person, the protocol compliance engine 106 is configured to transform the collected information of the person where the sensitive areas of the person's body and/or clothing are hidden from the sight of the user of the system 100. In the meantime, part of the human body (e.g., the person's face) is still shown after pixelization for identification of the person in violation of the set of protocols at the zone of interest. By pixelization/blurring of the person/object under surveillance as well as storing the information in the secure local storage 103, the system 100 ensures that the identify/privacy of the person is preserved, e.g., in hospitals where the privacy of patients in their individual rooms or bathroom is important, while the user is still able to review the notification of any protocol violation without infringing on the person's privacy.

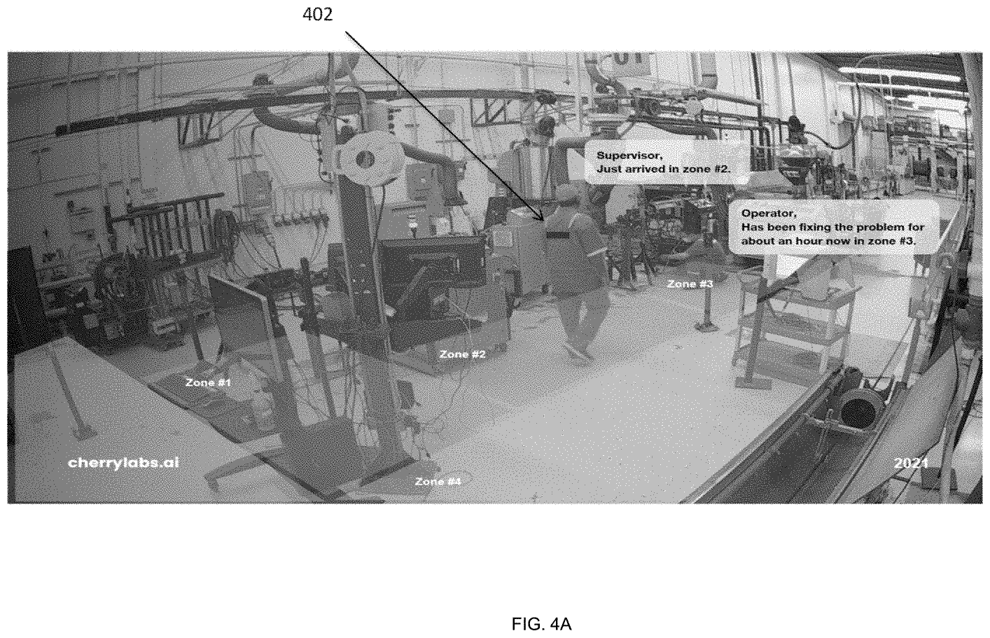

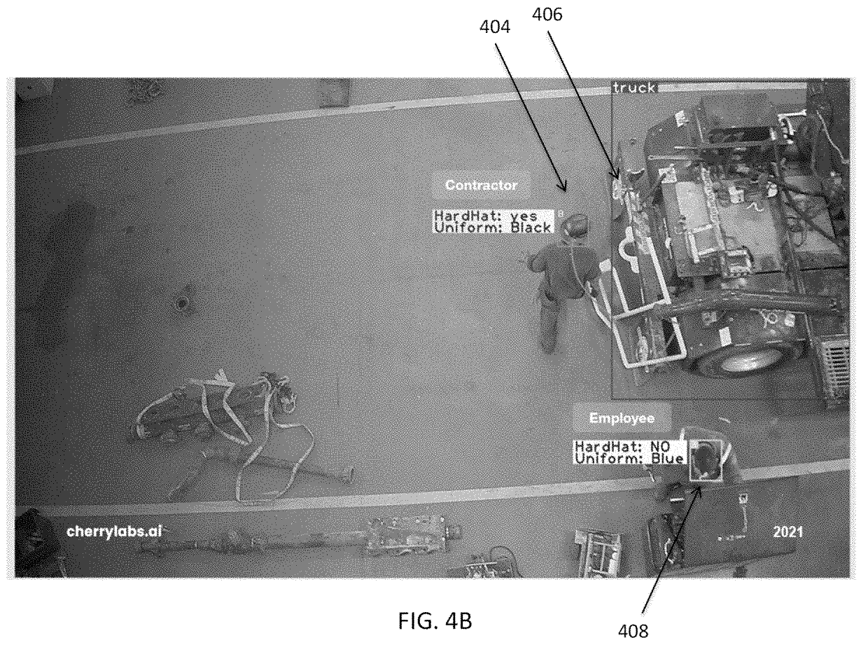

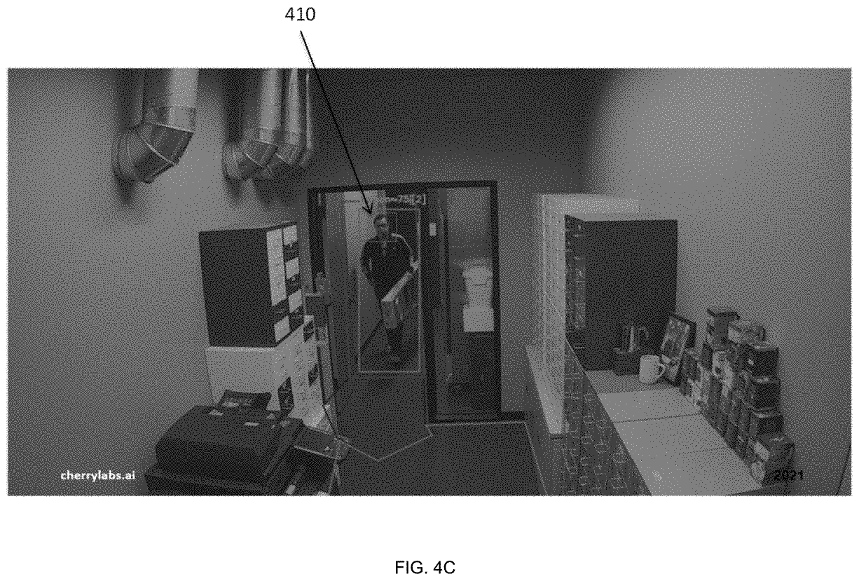

FIGS. 4A-4C depict examples of various use cases where protocol compliance is required to ensure employees are following production protocols/procedures in order to adhere to operational efficiency requirement. FIG. 4A shows an example of a typical factory environment where multiple zones of interest, e.g., Zone #1 to #4, are defined for compliance with a set of protocols for the factory environment. Worker/operator 402 is working in the zones of the interest and his presence, postures/activities, and the duration of his activities are monitored by the system 100 in order to determine that worker 402 follows the set of protocols for the factory environment. During his work, worker 402 keeps communication with his operator and any deviation from the set of protocols will trigger an alert of non-compliance, which will be addressed systematically by the employer's internal protocols. The ability to monitor and analyze if operation procedures are being followed by the employees in real time directly affects factory efficiency and proper training of workers, which will inevitably result in cost-savings in the factory bottom-line costs. FIG. 4B shows examples of identification of violations of a safety protocol where presence of a person 404 in black uniform is detected and recognized as an unauthorized contractor in a predetermined danger zone where a high-risk object 406, e.g., a truck, is detected/classified. Moreover, the posture of the contractor indicates that a dangerous situation is apparent because he might not be visible to the truck driver. Another employee 408 in blue uniform is also in violation because he does not wear a hardhat. FIG. 4C describes an example of compliance with a COVID19 regulation required by employers to track each incoming employee 410 who enters an office area/zone and is required to stand in front of a kiosk station to have the body temperature and mask checked for a certain duration of time until the temperature/mask pass the requirement.

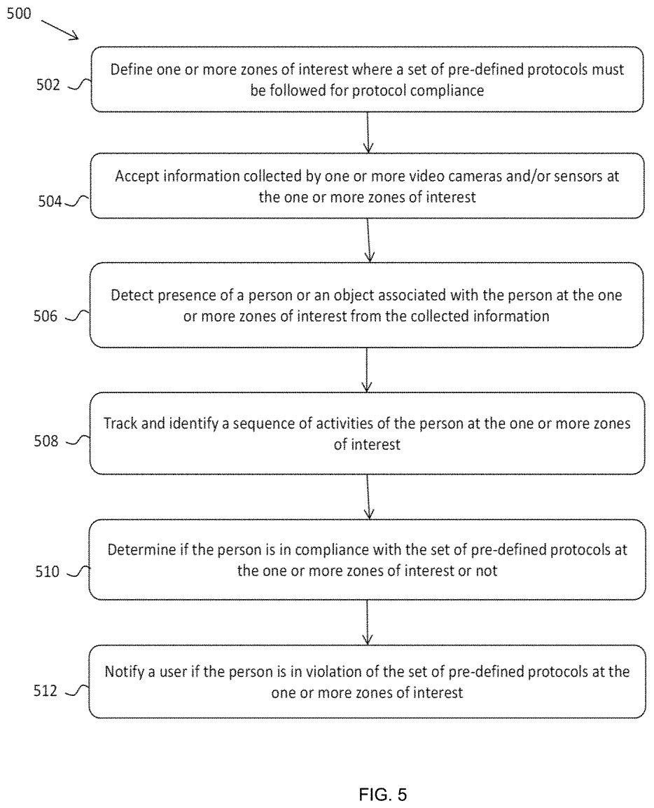

FIG. 5 depicts a flowchart 500 of an example of a process to support protocol compliance tracking. Although the figure depicts functional steps in a particular order for purposes of illustration, the processes are not limited to any particular order or arrangement of steps. One skilled in the relevant art will appreciate that the various steps portrayed in this figure could be omitted, rearranged, combined and/or adapted in various ways.

In the example of FIG. 5, the flowchart 500 starts at block 502, where one or more zones of interest, where a set of pre-defined protocols must be followed for protocol compliance are defined. The flowchart 500 continues to block 504, where information collected by one or more video cameras and/or sensors at the one or more zones of interest is accepted. The flowchart 500 continues to block 506, where presence of a person or an object associated with the person at the one or more zones of interest is detected from the collected information. The flowchart 500 continues to block 508, where a sequence of activities of the person at the one or more zones of interest is tracked and identified. The flowchart 500 continues to block 510, where it is determined whether the person is in compliance with the set of pre-defined protocols at the one or more zones of interest or not. The flowchart 500 ends at block 512, where a user is notified if the person is in violation of the set of pre-defined protocols at the one or more zones of interest.

One embodiment may be implemented using a conventional general purpose or a specialized digital computer or microprocessor(s) programmed according to the teachings of the present disclosure, as will be apparent to those skilled in the computer art. Appropriate software coding can readily be prepared by skilled programmers based on the teachings of the present disclosure, as will be apparent to those skilled in the software art. The invention may also be implemented by the preparation of integrated circuits or by interconnecting an appropriate network of conventional component circuits, as will be readily apparent to those skilled in the art.

The methods and system described herein may be at least partially embodied in the form of computer-implemented processes and apparatus for practicing those processes. The disclosed methods may also be at least partially embodied in the form of tangible, non-transitory machine readable storage media encoded with computer program code. The media may include, for example, RAMs, ROMs, CD-ROMs, DVD-ROMs, BD-ROMs, hard disk drives, flash memories, or any other non-transitory machine-readable storage medium, wherein, when the computer program code is loaded into and executed by a computer, the computer becomes an apparatus for practicing the method. The methods may also be at least partially embodied in the form of a computer into which computer program code is loaded and/or executed such that the computer becomes a special-purpose computer for practicing the methods. When implemented on a general-purpose processor, the computer program code segments configure the processor to create specific logic circuits. The methods may alternatively be at least partially embodied in a digital signal processor formed of application-specific integrated circuits for performing the methods.

What is claimed is:

1. A system to support protocol compliance tracking, comprising:
a human activity tracking engine configured to
define one or more zones of interest where a set of pre-defined protocols must be followed for protocol compliance;
accept information collected by one or more video cameras and/or sensors at the one or more zones of interest;
detect presence of a person or an object associated with the person at the one or more zones of interest from the collected information;
track and identify a sequence of activities of the person at the one or more zones of interest;
a protocol compliance engine configured to
determine if the person is in compliance with the set of pre-defined protocols at the one or more zones of interest or not;
notify a user of the system if the person is in violation of the set of pre-defined protocols at the one or more zones of interest.

2. The system of claim 1, wherein:
each of the one or more zones of interest is a factory area or a designated area.

3. The system of claim 1, wherein:
the set of pre-defined protocols includes one or more of ranges or scopes of the zones of interest where the activities of the person is being monitored, presence of the person and/or his or her activities in the zones of interest allowed, and the duration of the person's activities in the zones of interest permitted.

4. The system of claim 1, further comprising:
a local storage configured to securely maintain the collected information of the person at the one or more zones of interest, wherein the secured local storage is accessible under data access control policies.

5. The system of claim 1, wherein:
the human activity tracking engine is configured to generate, train, and utilize a plurality of artificial intelligence (AI) models to track and identify the sequence of activities of the person at the one or more zoned of interest.

6. The system of claim 5, wherein:
the human activity tracking engine is configured to train the plurality of AI models using the information collected at the one or more zones of interest.

7. The system of claim 1, wherein:
the human activity tracking engine is configured to identify and classify a certain posture or an activity of the person using one or more still images taken at the one or more zoned of interest.

8. The system of claim 1, wherein:
the human activity tracking engine is configured to track and/or record amount of time the person spent in the one or more zones of interest or doing certain activities in order to ascertain the person's compliance with the set of pre-defined protocols.

9. The system of claim 1, wherein:
the protocol compliance engine is configured to alert the person directly that his/her activities are not in compliance with the set of pre-defined protocols and need to be corrected if the person is in violation of the set of pre-defined protocols at the one or more zones of interest.

10. The system of claim 9, wherein:
the protocol compliance engine is configured to utilize an existing alarm system to notify the person of a violation event in order to minimize the risk to the person and/or other affected/surrounding person.

11. The system of claim 1, wherein:
the protocol compliance engine is configured to accept input from an existing alarm system to identify an escalation event when the set of pre-defined protocols is being violated.

12. The system of claim 1, wherein:
the user data privacy engine is configured to protect privacy and/or identity of the person by pixelizing or blurring a portion of the body of the person in an image when notifying the user of the system.

13. A method to support protocol compliance tracking, comprising:
defining one or more zones of interest where a set of pre-defined protocols must be followed for protocol compliance;
accepting information collected by one or more video cameras and/or sensors at the one or more zones of interest;
detecting presence of a person or an object associated with the person at the one or more zones of interest from the collected information;
tracking and identifying a sequence of activities of the person at the one or more zones of interest;
determining if the person is in compliance with the set of pre-defined protocols at the one or more zones of interest or not;
notifying a user if the person is in violation of the set of pre-defined protocols at the one or more zones of interest.

14. The method of claim 13, further comprising:
securely maintaining the collected information of the person at the one or more zones of interest on a secured local storage, wherein the secured local storage is accessible under data access control policies.

15. The method of claim 13, further comprising:
generating, training, and utilizing a plurality of artificial intelligence (AI) models to track and identify the sequence of activities of the person at the one or more zoned of interest.

16. The method of claim 15, further comprising:
training the plurality of AI models using the information collected at the one or more zones of interest.

17. The method of claim 13, further comprising:
identifying and classifying a certain posture or an activity of the person using one or more still images taken at the one or more zoned of interest.

18. The method of claim 13, further comprising:
tracking and/or recording amount of time the person spent in the one or more zones of interest or doing certain activities in order to ascertain the person's compliance with the set of pre-defined protocols.

19. The method of claim 13, further comprising:
alerting the person directly that his/her activities are not in compliance with the set of pre-defined protocols and need to be corrected if the person is in violation of the set of pre-defined protocols at the one or more zones of interest.

20. The method of claim 19, further comprising:
utilizing an existing alarm system to notify the person of a violation event in order to minimize the risk to the person and/or other affected/surrounding person.

21. The method of claim 13, further comprising:
accepting input from an existing alarm system to identify an escalation event when the set of pre-defined protocols is being violated.

22. The method of claim 13, further comprising:
protecting privacy and/or identity of the person by pixelizing or blurring a portion of the body of the person in an image when notifying the user.
